(19) United States
(12) Patent Application Publication
(10) Pub. No.: US 2026/0148586 A1
(43) Pub. Date: May 28, 2026

(54) CUSTOMER BEHAVIOR TRACKING METHOD, CUSTOMER BEHAVIOR TRACKING SYSTEM AND BEHAVIOR ANALYZING UNIT

(71) Applicant: INDUSTRIAL TECHNOLOGY RESEARCH INSTITUTE, Hsinchu (TW)

(72) Inventors: Yi-Chun CHEN, Zhubei City (TW); Chi-Yuan YEH, Hsinchu City (TW); Hsin-Chien HUANG, Hsinchu City (TW)

(73) Assignee: INDUSTRIAL TECHNOLOGY RESEARCH INSTITUTE, Hsinchu (TW)

(21) Appl. No.: 19/047,377

(22) Filed: Feb. 6, 2025

(30) Foreign Application Priority Data
Nov. 28, 2024 (TW) 113145982

(51) Int. Cl. G06V 40/20; G06Q 20/18; G06V 20/40; G06V 20/52

(52) U.S. Cl. CPC G06V 40/20; G06Q 20/18; G06V 20/41; G06V 20/44; G06V 20/49; G06V 20/52

(57) ABSTRACT

A customer behavior tracking method, a customer behavior tracking system and a behavior analyzing unit are provided. The customer behavior tracking method includes the following steps. A key user who enters a recognition area is bound by a multi-target tracking component connected to a plurality of image capture units. At least one key action of the key user for a product is recognized by at least one artificial intelligence of things (AIoT) element. The key action includes a taking action. A key video segment is cropped according to the key action. The taking action is the starting point of the key video segment. A vision language model is used to recognize a product item of the product. Based on the product item of the product, a checkout behavior or a purchase behavior of the key user for the product is recognized.

This application claims the benefit of Taiwan application Serial No. 113145982, filed Nov. 28, 2024, the disclosure of which is incorporated by reference herein in its entirety.

### TECHNICAL FIELD

The disclosure relates to a customer behavior tracking method, a customer behavior tracking system and a behavior analyzing unit.

### BACKGROUND

With the digital upgrade of the retail environment, shopping surveillance technology has become increasingly mature, and many stores have begun to rely on cameras and sensors to monitor and analyze passenger flow and customer behaviors. However, most of the existing systems focus on real-time recording and monitoring, and cannot accurately recognize key actions in customers'shopping behaviors. For example, in a self-service checkout environment, abnormal behaviors include a behavior that the barcode of the product was not scanned or a behavior that a barcode of a wrong product was scanned, and cannot be detected in the physical store. In the retail store, customer purchase behaviors and customer preferences and potential shopping intentions are not easily to obtained.

Therefore, the research and development goals in the industry is how to accurately recognize checkout behaviors or purchase behaviors to avoid, for example, a behavior that the barcode of the product was not scanned or a behavior that a barcode of a wrong product was scanned; and to, for example, proactively and immediately provide relevant tips to customers to increase purchasing motivation.

### SUMMARY

The disclosure is directed to a customer behavior tracking method, a customer behavior tracking system and a behavior analyzing unit. According to a key action, a key video segment is cropped to correctly recognize the user's checkout behavior or purchase behavior through the key video segment.

According to one embodiment, a customer behavior tracking method is provided. The customer behavior tracking method includes the following steps. A key user who enters a recognition area is bound by a multi-target tracking component connected to a plurality of image capture units. At least one key action of the key user for a product is recognized by at least one artificial intelligence of things (AIoT) element. The key action includes a taking action. A key video segment is cropped according to the key action. The taking action is a starting point of the key video segment. A product item of the product is recognized according to the key video segment via a vision language model. A checkout behavior or a purchase behavior of the key user for the product is recognized according to the product item of the product.

According to another embodiment, a customer behavior tracking system is provided. The customer behavior tracking system includes a behavior recognition module. The behavior recognition module includes a plurality of image capture units and a behavior analyzing unit. The behavior analyzing unit includes a multi-target tracking component, at least one artificial intelligence of things (AIoT) element, a video cropping component and a vision language model (VLM). The multi-target tracking component is connected to the image capture units. The multi-target tracking component is used to bind a key user who enters a recognition area. The artificial intelligence of things (AIoT) element is used to recognize at least one key action of the key user for a product. The key action includes a taking action. The video cropping component is used to crop a key video segment according to the key action. The taking action is a starting point of the key video segment. The vision language model (VLM) is used to recognize a product item of the product according to the key video segment. A checkout behavior or a purchase behavior of the key user for the product is recognized according to the product item of the product.

According to an alternative embodiment, a behavior analyzing unit is provided. The behavior analyzing unit includes a multi-target tracking component, at least one artificial intelligence of things (AIoT) element, a video cropping component and a vision language model (VLM). The multi-target tracking component is connected to a plurality of image capture units. The multi-target tracking component is used to bind a key user who enters a recognition area. The artificial intelligence of things (AIoT) element is used to recognize at least one key action of the key user for a product. The key action includes a taking action. The video cropping component is used to crop a key video segment according to the key action. The taking action is a starting point of the key video segment. The vision language model (VLM) is used to recognize a product item of the product according to the key video segment. A checkout behavior or a purchase behavior of the key user for the product is recognized according to the product item of the product.

### BRIEF DESCRIPTION OF THE DRAWINGS

FIG. 1 illustrates a behavior that a barcode of a product was not scanned according to an embodiment of the present disclosure.

FIG. 2 illustrates a behavior that a barcode of a wrong product was scanned according to an embodiment of the present disclosure.

FIG. 3 illustrates a block diagram of a customer behavior tracking system according to one embodiment of the present disclosure.

FIG. 4 illustrates a flow chart of a customer behavior tracking method executed in a product checkout area according to one embodiment of the present disclosure.

FIG. 5 illustrates an example of the step S110 in FIG. 4.

FIG. 6 illustrates an example of the step S120 in FIG. 4.

FIGS. 7A to 7B illustrate an example of the step S130 in the FIG. 4.

FIGS. 8A to 8B illustrate another example of the step S130 in the FIG. 4.

FIGS. 9A to 9B illustrate another example of the step S130 in FIG. 4.

FIG. 10 illustrates an example of the steps S140 to S150 in the FIG. 4.

FIG. 11 illustrates a detailed flow chart of the step S160 according to an embodiment of the present disclosure.

FIG. 12 illustrates a block diagram of a smart self-checkout system according to an embodiment of the present disclosure.

FIG. 13 illustrates a flow chart of the customer behavior tracking method applied to the product storage area according to an embodiment of the present disclosure.

FIG. 14 illustrates the execution of the steps in FIG. 13.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

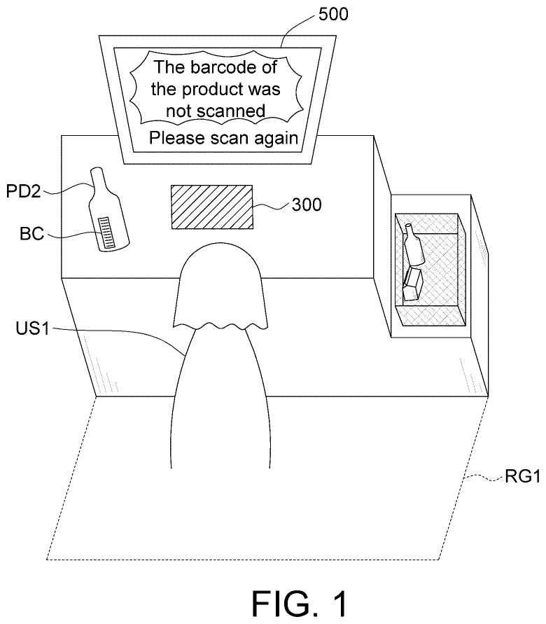

Please refer to FIG. 1, which illustrates a behavior that a barcode of a product was not scanned according to an embodiment of the present disclosure. In one embodiment, in a recognition area RG1 in front of a self-checkout system, a key user US1 is performing a checkout action for a product PD2. However, a barcode BC of the product PD2 may not be correctly putted on a product scanning module 300, resulting in the behavior that the barcode BC of the product PD2 was not scanned. In this embodiment, the checkout screen 500 will immediately display “The barcode of the product was not scanned” to provide an interactive reminder, and ask the key user US1 to scan the product PD2 again.

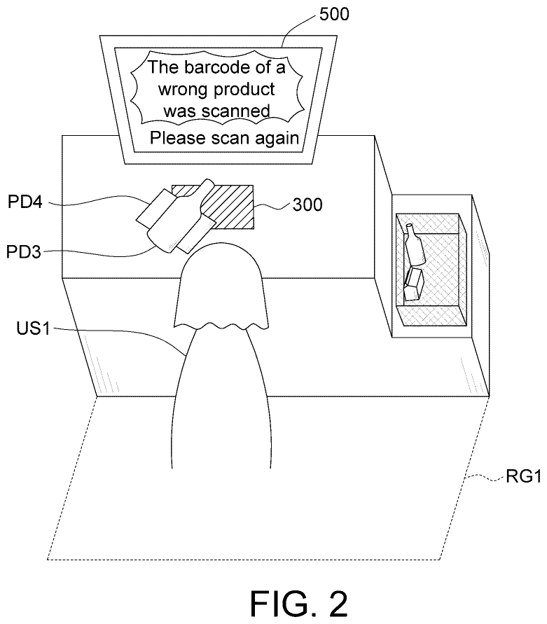

Please refer to FIG. 2, which illustrates a behavior that a barcode of a wrong product was scanned according to an embodiment of the present disclosure. In another embodiment, the key user US1 may mistakenly scan a barcode BC of a product PD4 when performing the checkout action for the product PD3, and a behavior that the barcode of a wrong product was scanned occurs. In this embodiment, the checkout screen 500 will immediately display “The barcode of the wrong product was scanned” to provide an interactive reminder, and ask the key user US1 to scan the product PD3 again.

In the above-mentioned examples of a behavior that a barcode of a product was not scanned or a behavior that a barcode of a wrong product was scanned, the two behaviors cannot be recognized simply through the product scanning module 300. Instead, in the technology of this disclosure, the video recognition technology is used to perform the cross-comparison on a behavior database, such that the recognition rate of the abnormal behavior can be improved.

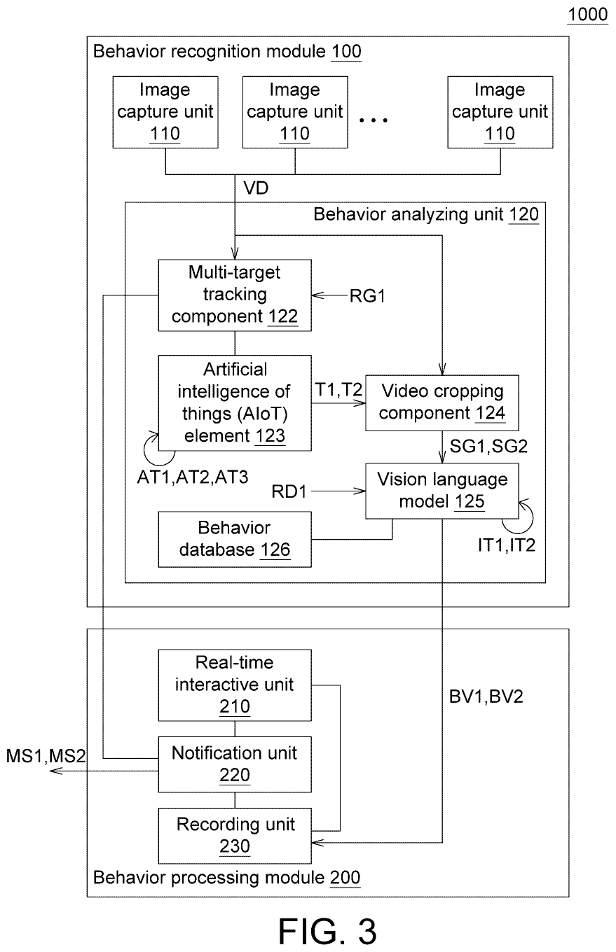

Please refer to FIG. 3, which illustrates a block diagram of a customer behavior tracking system 1000 according to one embodiment of the present disclosure. The customer behavior tracking system 1000 includes a behavior recognition module 100 and a behavior processing module 200. The behavior recognition module 100 includes a plurality of image capture units 110 and a behavior analyzing unit 120.

The behavior analyzing unit 120 includes a multi-target tracking component 122, at least one artificial intelligence of things (AIoT) element 123, a video cropping component 124, a vision language model (VLM) 125 and a behavior database 126. The behavior processing module 200 includes a real-time interactive unit 210, a notification unit 220 and a recording unit 230.

The multi-target tracking component 122 is used for human tracking. The artificial intelligence of things (AIoT) element 123 is used for behavioral detection. The video cropping component 124 is used to crop video. The vision language model 125 is used to perform inference procedures. The real-time interactive unit 210 is used to generate interactive messages. The notification unit 220 is used to perform information notification procedures. The multi-target tracking component 122, the artificial intelligence of things (AIoT) element 123, the video cropping component 124, the vision language model 125, the real-time interactive unit 210 and/or the notification unit 220 is, for example, a circuit, a circuit board, a storage device that stores program code, or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The behavior database 126 and the recording unit 230 are used to record and store data, such as any type of fixed or removable random access memory (RAM), read-only memory (ROM), flash memory, hard disk drive (HDD), solid state drive (SSD) or similar components or a combination of the above components, used to store multiple modules or various applications that could be executed by the processor. The behavior database 126 records various consumption behaviors or abnormal behaviors. During the operation of the customer behavior tracking system 1000, the behavior database 126 could update the data according to the feedback information on the recognition results or the additional supplementary information provided by the staff, so that the customer behavior tracking system 1000 could obtain more accurate recognition results.

In the product checkout area, when the key user US1 makes a mistake during checkout, the customer behavior tracking system 1000 could immediately notify the key user US1 to checkout again to avoid checkout errors. The following is a flowchart to explain in detail the operation of the above components.

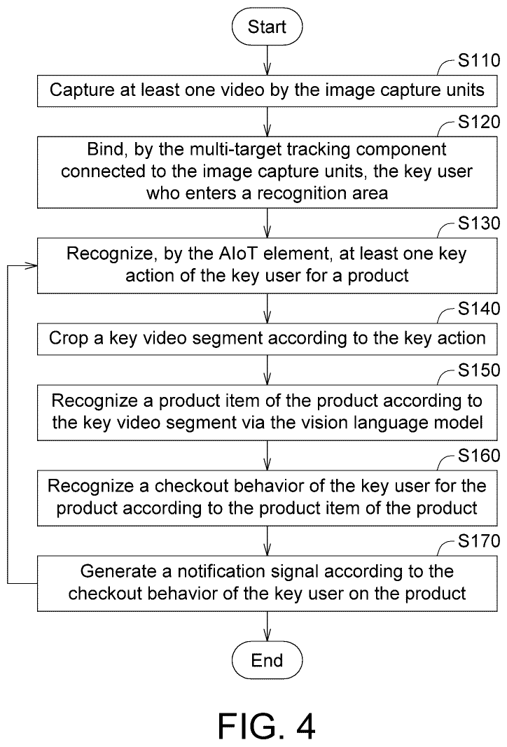

Please refer to FIG. 4, which illustrates a flow chart of a customer behavior tracking method executed in a product checkout area according to one embodiment of the present disclosure. The customer behavior tracking method of the FIG. 4 includes step S110 to step S170. The customer behavior tracking system 1000 and the customer behavior tracking method disclosed in this disclosure could be applied to the product checkout area and the product storage area. The following takes the product checkout area as an example for explanation.

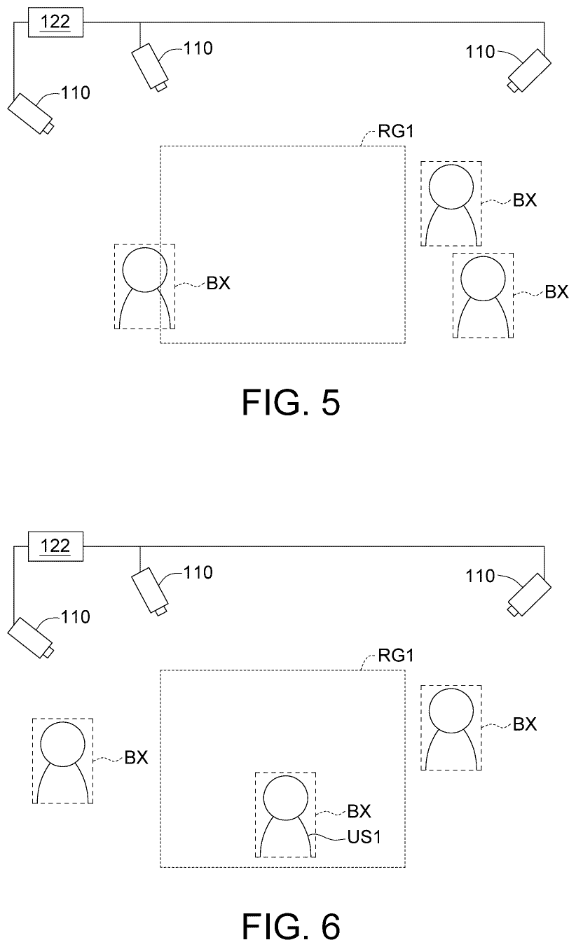

Please refer to FIG. 5, which illustrates an example of the step S110 in FIG. 4. In the step S110, as shown in the FIGS. 3 and 5, these image capture units 110 are used to capture at least one video VD. In this step, when a plurality of customers move in the store, the multi-target tracking component 122 connected to the image capture unit 110 will use the multi-target multi-camera (MTMC) to track these customers and display a plurality of human boxes BX on the video VD.

Next, please refer to FIG. 6, which illustrates an example of the step S120 in FIG. 4. In step S120, as shown in the FIGS. 3 and 6, the key user US1 entering the recognition area RG1 is bound by the multi-target tracking component 122 connected to the image capture units 110. In this step, when the multi-target tracking component 122 tracks that one of the customers has entered the recognition area RG1, this customer is bound as the key user US1. In one embodiment, the multi-target tracking component 122 could bind the customer according to the degree of overlap between the recognition area RG1 and the customer, or according to the staying time of the customer in the recognition area RG1. Once a customer leaves the recognition area RG1, this customer will not be bound as the key user US1.

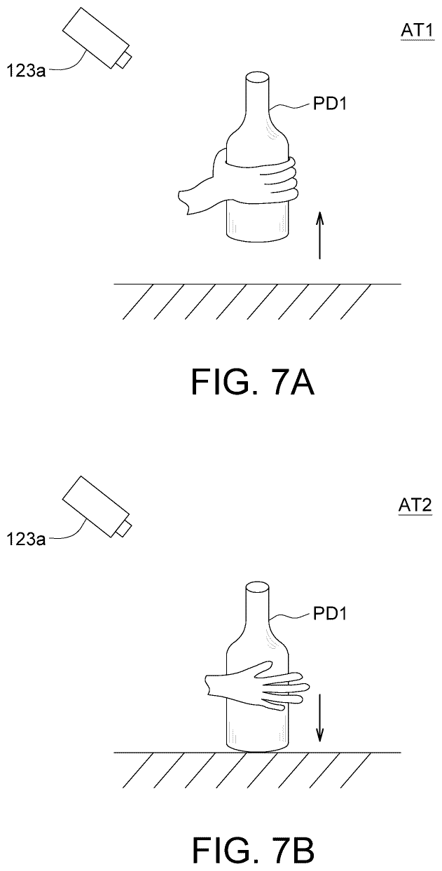

Then, please refer to FIGS. 7A to 7B, which illustrate an example of the step S130 in the FIG. 4. In the step S130, as shown in the FIG. 3 and the FIGS. 7A to 7B, the AIoT element 123 recognizes at least one key action of the key user US1 on the product PD1. For example, a key action AT1 is a taking action, and a key action AT2 is a putting action. The AIoT element 123 is, for example, an image recognition component 123a illustrated in the FIGS. 7A and 7B.

In this step, when the image recognition component 123a detects that the product PD1 is picked up by the key user US1, it is determined as the key action AT1; when the image recognition component 123a detects that the product PD1 is put down, it is determined as the key action AT2.

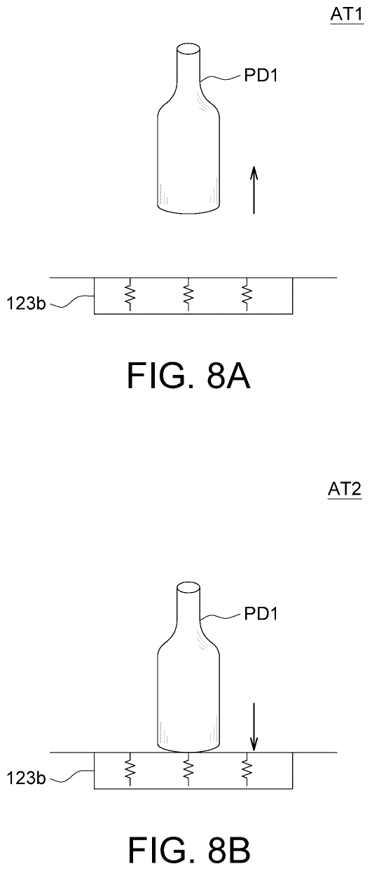

Please refer to FIGS. 8A to 8B, which illustrate another example of the step S130 in the FIG. 4. The AIoT element 123 is, for example, a weight sensing element 123b illustrated in the FIGS. 8A and 8B. When the weight sensing element 123b senses a weight reduction, it is determined as the key action AT1; when the weight sensing element 123b senses a weight recovery, it is determined as the key action AT2.

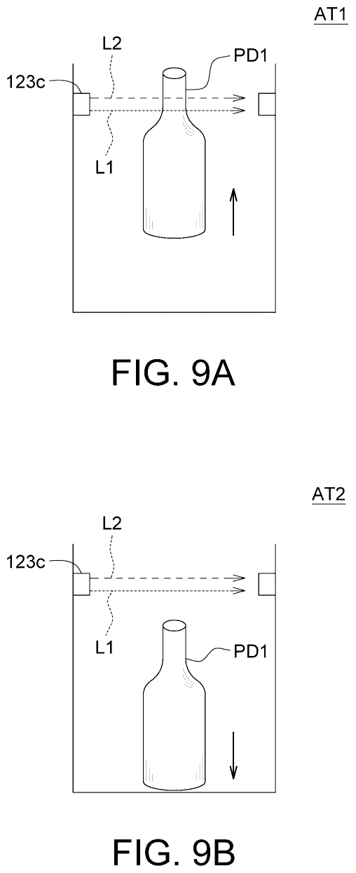

Please refer to FIGS. 9A to 9B, which illustrate another example of the step S130 in FIG. 4. The AIoT element 123 is, for example, an infrared sensing element 123c illustrated in the FIGS. 9A and 9B. When the infrared sensing element 123c senses that an item passes through two infrared rays L1 and L2 in a certain order, it is determined as the key action AT1. When the infrared sensing element 123c senses that an item passes through the infrared rays L1 and L2 in a reverse order, it is determined as the key action AT2.

In addition to the image recognition component 123a, the weight sensing element 123b, the infrared sensing element 123c, the AIoT element 123 could also be a lidar sensing element.

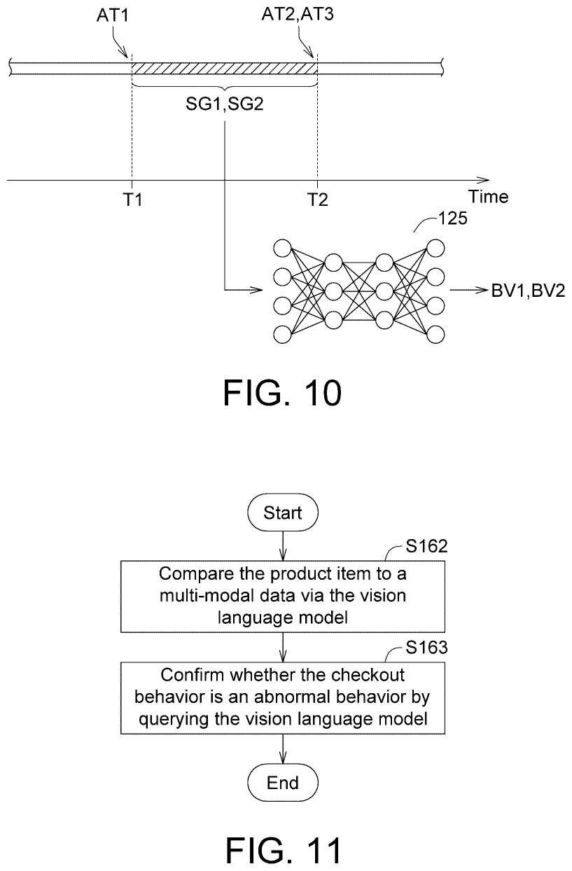

Next, please refer to FIG. 10, which illustrates an example of the steps S140 to S150 in the FIG. 4. In the step S140, as shown in the FIGS. 3 and 10, the video cropping component 124 crops a key video segment SG1 according the at least one key action. The time point T1 of the key action AT1 (e.g. the taking action) is the starting point of the key video segment SG1, and the time point T2 of the key action AT2 (e.g. putting action) is the end point of the key video segment SG1. Through the setting of the start point and the end point, the process of taking the product PD1 could be accurately cropped, so that the subsequent recognition process could be more accurate.

Then, in the step S150, as shown in the FIGS. 3 and 10, the vision language model 125 recognizes a product item IT1 of the product PD1 according to the key video segment SG1. For example, the vision language model 125 could recognizes the name, the quantity, the color or other information in the product item IT1 of the product PD1. Since the key video segment SG1 corresponds to the product PD1, the vision language model 125 would not be interfered by too many products and could more accurately recognize the product PD1.

Next, in the step S160, as shown in the FIG. 3, a checkout behavior BV1 of the key user US1 on the product PD1 is recognized according to the product item IT1 of the product PD1. For example, in this step, the vision language model 125 recognizes, via the behavior database 126, the checkout behavior BV1 of the key user US1 on the product PD1. The behavior database 126 could be updated according to the feedback information on the recognition results or the additional supplementary information provided by the staff.

Please refer to FIG. 11, which illustrates a detailed flow chart of the step S160 according to an embodiment of the present disclosure. In one embodiment, the step S160 includes step S162 to step S163.

In the step S162, the vision language model 125 compares the product item IT1 with a multi-modal data. The multi-modal data is, for example, a product scan record RD1. In another embodiment, the multi-modal data could be, for example, a customer behavior video or a product weight change data.

Then, in the step S163, it is confirmed whether the checkout behavior is an abnormal behavior by querying the vision language model 125. As shown in the FIG. 1, when the product item IT1 does not exist in the product scan record RD1, the vision language model 125 will recognize, via the behavior database 126, that an abnormal behavior that the barcode of the product PD1 was not scanned by the key user US1.

As shown in the FIG. 2, when the product item IT1 and the product scan record RD1 are different, the vision language model 125 will recognize, via the behavior database 126, an abnormal behavior that the barcode of a wrong product was scanned by the key user US1. The behavior database 126 could be updated according to the feedback information on the recognition results or the additional supplementary information provided by the staff.

Then, in the step S170, as shown in the FIG. 3, the notification unit 220 generates a notification signal MS1 according to the checkout behavior BV1 of the key user US1 on the product PD1. In the example of the product checkout area, the real-time interactive unit 210 generates the content of the notification signal MS1 according to the checkout behavior BV1 of the key user US1 on the product PD1. For example, the notification signal MS1 is displayed on the checkout screen 500 in the FIGS. 1 and 2 to remind the key user US1 that there is the abnormal behavior that the barcode of the product PD1 was not scanned or the barcode of a wrong product was scanned. Alternatively, the notification signal MS1 could also be directly sent to the operator, so that the staff can go to assist in processing.

According to the above customer behavior tracking method, the key video segment SG1 is cropped according to the key actions AT1 and AT2, so as to correctly recognize the checkout behavior BV1 of the key user key user US1 through the key video segment SG1. In case of the abnormal behavior that the barcode of the product PD1 was not scanned or the barcode of a wrong product was scanned happened, it could promptly remine the staff of the abnormal behaviors and handle them.

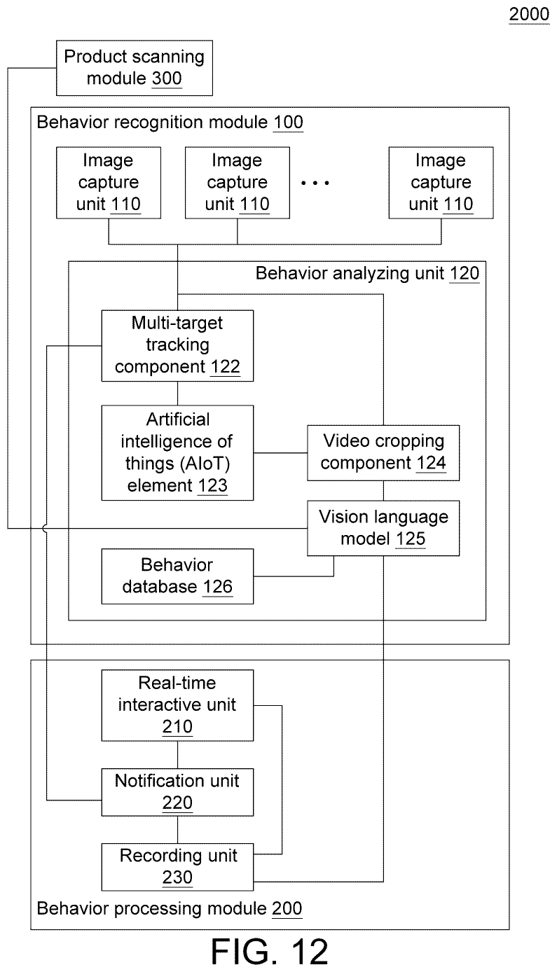

Please refer to FIG. 12, which illustrates a block diagram of a smart self-checkout system 2000 according to an embodiment of the present disclosure. The customer behavior tracking system 1000 described in the above embodiment could be applied in the smart self-checkout system 2000. The smart self-checkout system 2000 includes the above-mentioned product scanning module 300, the above-mentioned behavior recognition module 100 and the above-mentioned behavior processing module 200.

The components of the behavior recognition module 100 and the behavior processing module 200 is the same as the components described above, and will not be described again here.

In this embodiment, during the self-checkout process, the smart self-checkout system 2000 could crop out the key video segment SG1 according to the key actions AT1 and AT2, so as to correctly recognize the checkout behavior of the key user US1 through the key video segment SG1. In case of the abnormal behavior that the barcode of the product PD1 was not scanned or the barcode of a wrong product was scanned happened, it could promptly remine the staff of the abnormal behaviors and handle them.

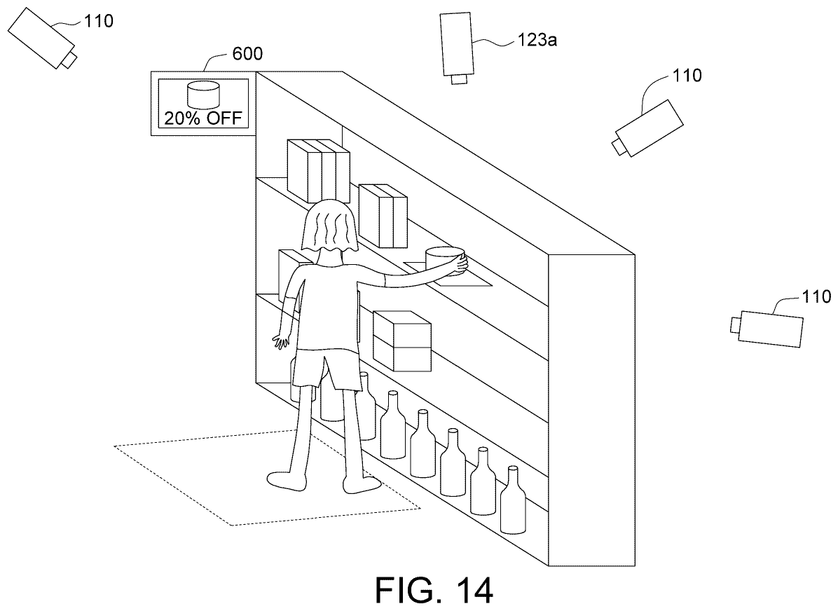

In another embodiment, the above-mentioned customer behavior tracking system 1000 could also be applied to the product storage area to correctly recognize a purchase behavior BV2 of the key user US2 (shown in the FIG. 14). The following is a flowchart to explain in detail how the components of the customer behavior tracking system 1000 operate in the product storage area.

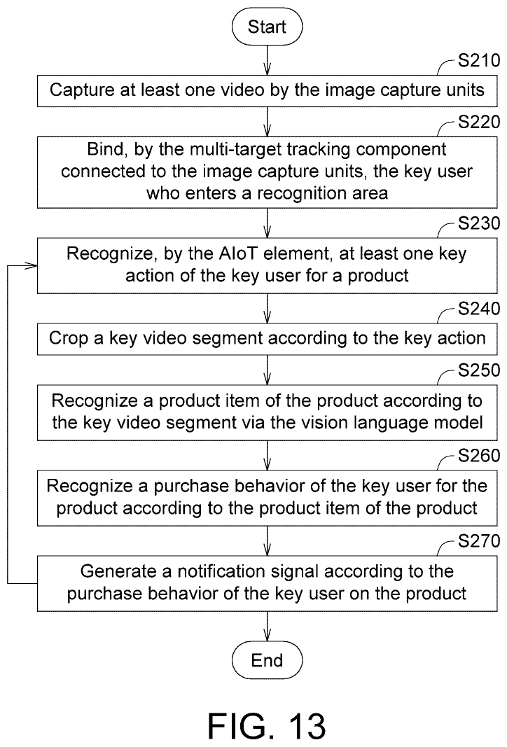

Please refer to FIGS. 13 and 14 at the same time. FIG. 13 illustrates a flow chart of the customer behavior tracking method applied to the product storage area according to an embodiment of the present disclosure. FIG. 14 illustrates the execution of the steps in FIG. 13. The customer behavior tracking method in the FIG. 13 includes steps S210 to S270.

In the step S210, as shown in the FIGS. 3 and 13, the image capture units 110 capture at least one video VD. In this step, when several customers move in the store, the multi-target tracking component 122 connected to the image capture units 110 tracks the customers via the multi-target tracking technology (MTMC).

Then, in the step S220, as shown in the FIGS. 3 and 13, the multi-target tracking component 122 connected to the image capture units 110 binds the key user US2 entering the recognition area RG2. In this step, when the multi-target tracking component 122 tracks that one of the customers has entered recognition area RG2, it binds this customer as the key user US2. In one embodiment, the multi-target tracking component 122 could bind the person with the highest degree of overlap with the recognition area RG2 as the key user US2, or the person who has entered the recognition area RG2 for the longest time as the key user US2. Once a customer leaves the recognition area RG2, it would not be bound as the key user US2.

Then, in the step S230, as shown in the FIGS. 3 and 13, the artificial intelligence of things (AIoT) element 123 recognizes at least one key action of the key user US2 on the product PD5. For example, the key action AT1 is a taking action; the key action AT2 is a putting action; a key action AT3 is a leaving action of the key user US2 leaving the recognition area RG2. The artificial intelligence of things (AIoT) element 123 is, for example, a weight sensing element 123b in the FIG. 13. When the weight sensing element 123b senses a weight reduction, it is determined as the key action AT1; when the weight sensing element 123b senses a weight recovery, it is determined as the key action AT2.

The artificial intelligence of things (AIoT) element 123 is, for example, the image recognition component 123a in the FIG. 13. When the image recognition component 123a detects that the product PD5 is picked up by the key user US2, it is determined as the key action AT1; when the image recognition component 123a detects that the product PD5 is put down, it is determined as the key action AT2.

Then, in the step S240, as shown in the FIG. 3 and the FIG. 10, the video cropping component 124 crops the key video segment SG1 according to the at least one key action. The time point T1 of the key action AT1 (taking action) is the starting point of the key video segment SG2, and the time point T2 of the key action AT2 (putting action) or the key action AT3 (leaving action) is the end point of the key video segment SG2. Through the setting of the start point and the end point, the process of taking the product PD5 could be accurately captured, so that the subsequent recognition could be more accurate.

Then, in the step S250, as shown in the FIGS. 3 and 10, the vision language model 125 recognizes the product item IT2 of the product PD5 according to the key video segment SG2.

Next, in the step S260, as shown in the FIG. 3, the purchase behavior BV2 of the key user US2 for the product PD5 is recognized according to the product item IT2 of the product PD5. For example, in this step, the vision language model 125 could recognize the purchase behavior BV2 of the key user US2 for product PD5 via the behavior database 126. The purchase behavior BV2 includes actions such as direct taking, repeated comparison, and price inquiry. The behavior database 126 could be updated according to the feedback information on the recognition results or the additional supplementary information provided by the staff.

Then, in the step S270, as shown in the FIG. 3, the notification unit 220 generates a notification signal MS2 according to the purchase behavior BV2 of the key user US2 for the product PD5. In the example of the product storage area, the real-time interactive unit 210 generates the notification signal MS2 according to the purchase behavior BV2 of the key user US2 for the product PD5. The notification signal MS2 is, for example, promotional information, recommendation information, etc. displayed on an advertising screen 600 in the FIG. 13, or a message displayed on a mobile phone of the key user US2 to increase purchase motivation.

According to the above embodiment, through the collaborative operation of the artificial intelligence of things (AIoT) element 123 (such as ceiling cameras, shelf weight sensors), the key actions AT1, AT2, AT3, such as the action of holding the product and the weight change on the machine, to crop the key video segment SG2 required by the vision language model 125. The vision language model 125 could correctly recognize the purchase behavior BV2 of the key user US2 through the shorter key video segment SG2. Using the information of the purchase behavior BV2, the key user US2 could instantly receive promotions and related product promotions during shopping. It could not only provide the key user US2 with a reference for purchasing, but also effectively increase the purchasing motivation.

It will be apparent to those skilled in the art that various modifications and variations could be made to the disclosed embodiments. It is intended that the specification and examples be considered as exemplars only, with a true scope of the disclosure being indicated by the following claims and their equivalents.

What is claimed is:

1. A customer behavior tracking method, comprising:
binding, by a multi-target tracking component connected to a plurality of image capture units, a key user who enters a recognition area;
recognizing, by at least one artificial intelligence of things (AIoT) element, at least one key action of the key user for a product, wherein the key action includes a taking action;
cropping a key video segment according to the key action, wherein the taking action is a starting point of the key video segment;
recognizing a product item of the product according to the key video segment via a vision language model; and
recognizing a checkout behavior or a purchase behavior of the key user for the product according to the product item of the product.

2. The customer behavior tracking method according to claim 1, wherein the at least one key action further includes a putting action, and the putting action is an end point of the key video segment.

3. The customer behavior tracking method according to claim 1, wherein the at least one artificial intelligence of things (AIoT) element is an image recognition component, a weight sensing element, an infrared sensing element or a lidar sensing element.

4. The customer behavior tracking method according to claim 1, wherein the step of recognizing the checkout behavior or the purchase behavior of the key user for the product according to the product item of the product includes:
comparing the product item to a multi-modal data via the vision language model; and
confirming whether the checkout behavior is an abnormal behavior by querying the vision language model.

5. The customer behavior tracking method according to claim 4, wherein the multi-modal data includes a product scan record, a customer behavior video or a product weight change data.

6. The customer behavior tracking method according to claim 1, wherein the at least one key action further includes a leaving action of the key user leaving the recognition area, and the leaving action is an end point of the key video segment.

7. The customer behavior tracking method according to claim 1, further comprising:
generating a notification signal according to the checkout behavior or the purchase behavior of the key user for the product.

8. A customer behavior tracking system, comprising:
a behavior recognition module, including:
a plurality of image capture units;
a behavior analyzing unit, including:
a multi-target tracking component, connected to the image capture units, wherein the multi-target tracking component is used to bind a key user who enters a recognition area;
at least one artificial intelligence of things (AIoT) element, used to recognize at least one key action of the key user for a product, wherein the key action includes a taking action;
a video cropping component, used to crop a key video segment according to the key action, wherein the taking action is a starting point of the key video segment; and
a vision language model (VLM), used to recognize a product item of the product according to the key video segment, wherein a checkout behavior or a purchase behavior of the key user for the product is recognized according to the product item of the product.

9. The customer behavior tracking system according to claim 8, wherein the at least one key action further includes a putting action, and the putting action is an end point of the key video segment.

10. The customer behavior tracking system according to claim 8, wherein the at least one artificial intelligence of things (AIoT) element is an image recognition component, a weight sensing element, an infrared sensing element or a lidar sensing element.

11. The customer behavior tracking system according to claim 8, wherein
the vision language model is further used to compare the product item to a multi-modal data; and
whether the checkout behavior is an abnormal behavior is confirmed by querying the vision language model.

12. The customer behavior tracking system according to claim 11, wherein the multi-modal data includes a product scan record, a customer behavior video or a product weight change data.

13. The customer behavior tracking system according to claim 8, wherein the at least one key action further includes a leaving action of the key user leaving the recognition area, and the leaving action is an end point of the key video segment.

14. The customer behavior tracking system according to claim 8, further comprising:
a behavior processing module, including:
a notification unit, used to generate a notification signal according to the checkout behavior or the purchase behavior of the key user for the product.

15. The customer behavior tracking system according to claim 8, further comprising:
a behavior database, wherein the vision language model uses the behavior database to recognize the checkout behavior or the purchase behavior of the key user for the product, and the behavior database is updated according to a feedback information or an additional supplementary information.

16. A behavior analyzing unit, comprising:
a multi-target tracking component, connected to a plurality of image capture units, wherein the multi-target tracking component is used to bind a key user who enters a recognition area;
at least one artificial intelligence of things (AIoT) element, used to recognize at least one key action of the key user for a product, wherein the key action includes a taking action;
a video cropping component, used to crop a key video segment according to the key action, wherein the taking action is a starting point of the key video segment; and
a vision language model (VLM), used to recognize a product item of the product according to the key video segment, wherein a checkout behavior or a purchase behavior of the key user for the product is recognized according to the product item of the product.

17. The behavior analyzing unit according to claim 16, wherein the at least one key action further includes a putting action, and the putting action is an end point of the key video segment.

18. The behavior analyzing unit according to claim 16, wherein the at least one artificial intelligence of things (AIoT) element is an image recognition component, a weight sensing element, an infrared sensing element or a lidar sensing element.

19. The behavior analyzing unit according to claim 16, wherein
the vision language model is further used to compare the product item to a multi-modal data; and
whether the checkout behavior is an abnormal behavior is confirmed by querying the vision language model.

20. The behavior analyzing unit according to claim 19, wherein the multi-modal data includes a product scan record, a customer behavior video or a product weight change data.
